(19) United States
(12) Patent Application Publication
(10) Pub. No.: US 2002/0013411 A1
(43) Pub. Date: Jan. 31, 2002

(54) Crosslinkable compositions containing epoxidzed monohydroxylated diene polymers and amino resins

(76) Inventors: David John St. Clair, Houston, TX (US); James Robert Erickson, Katy, TX (US)

Correspondence Address: Donald F. Haas, C/O SHELL OIL COMPANY, Intellectual Property, P.O. Box 2463, Houston, TX, 77252-2463, US

(21) Appl. No.: 09/821,702

(22) Filed: Mar. 29, 2001

Related U.S. Application Data
(62) Division of application No. 08/438,427, filed on May 10, 1995, now abandoned.
Application No. 08/438,427 is a division of application No. 08/320,800, filed on Oct. 11, 1994, now abandoned.

(51) Int. Cl. C08L 53/00

(52) U.S. Cl. 525/92 B

(57) ABSTRACT

A crosslinkable composition comprising from 50 to 98 percent by weight of an epoxidized monohydroxylated polydiene polymer which is comprised of at least two polymerizable ethenically unsaturated hydrocarbon monomers wherein at least one is a diene monomer which yields unsaturation which is suitable for epoxidation, and from 50 to 2 percent by weight of an amino resin. The preferred polymer for use herein has the formula

(HO)ₓ-A-S_{z}-B-(OH)_{y}

wherein A and B are polymer blocks which may be homopolymer blocks of conjugated diolefin monomers, copolymer blocks of conjugated diolefin monomers, or copolymer blocks of diolefin monomers and monoalkenyl aromatic hydrocarbon monomers, S is a vinyl aromatic hydrocarbon block, x and y are 0 or 1 and either x or y must be 1 but only one at a time can be 1, and z is 0 or 1, and contains from 0.2 to 7.0 meq of epoxy per gram of polymer.

### BACKGROUND OF THE INVENTION

This invention relates to novel crosslinkable compositions of epoxidized monohydroxylated diene polymers and amino resins. More specifically, the invention relates to the use of particular epoxidized monohydroxylated polydiene polymers in crosslinking with amino resins to produce products which are useful in a variety of compositions such as adhesives, sealants, and coatings.

Hydroxy functional polydiene polymers are well known. It has been shown that formulations containing these polymers, a melamine resin, and an acid catalyst can be cured by baking under normal bake conditions. Most of these polymers are homopolymers of one diene or another. For example, monohydroxylated polybutadienes are known in the art for use in adhesive formulations. U.S. Pat. No. 4,242,468 describes solventless polyurethane coatings having improved flexibility resulting from incorporation of monohydroxylated polybutadienes. Epoxidized versions of hydroxylated polybutadienes are known as well. Low viscosity epoxidized polydiene polymers are also known, especially for use in adhesives. Such polymers are described in commonly assigned U.S. Pat. Nos. 5,229,464 and 5,247,026.

### SUMMARY OF THE INVENTION

This invention is a crosslinkable composition containing an epoxidized monohydroxylated polydiene polymer which is comprised of at least two polymerizable ethenically unsaturated hydrocarbon monomers wherein at least one is a diene monomer which yields unsaturation suitable for epoxidation, and an amino resin crosslinking agent. The preferred epoxidized monohydroxylated polymers are block copolymers of at least two conjugated dienes, preferably isoprene and butadiene, and, optionally, a vinyl aromatic hydrocarbon wherein a hydroxyl group is attached at one end of the polymer molecule. These polymers may be hydrogenated or unhydrogenated.

### DETAILED DESCRIPTION OF THE INVENTION

Polymers containing ethylenic unsaturation can be prepared by copolymerizing one or more olefins, particularly diolefins, by themselves or with one or more alkenyl aromatic hydrocarbon monomers. The copolymers may, of course, be random, tapered, block or a combination of these, as well as linear, star or radial.

The polymers containing ethylenic unsaturation or both aromatic and ethylenic unsaturation may be prepared using anionic initiators or polymerization catalysts. Such polymers may be prepared using bulk, solution or emulsion techniques. When polymerized to high molecular weight, the polymer containing at least ethylenic unsaturation will, generally, be recovered as a solid such as a crumb, a powder, a pellet or the like. When polymerized to low molecular weight, it may be recovered as a liquid such as in the present invention.

In general, when solution anionic techniques are used, copolymers of conjugated diolefins, optionally with vinyl aromatic hydrocarbons, are prepared by contacting the monomer or monomers to be polymerized simultaneously or sequentially with an anionic polymerization initiator such as group IA metals, their alkyls, amides, silanolates, napthalides, biphenyls or anthracenyl derivatives. It is preferred to use an organo alkali metal (such as sodium or potassium) compound in a suitable solvent at a temperature within the range from about −150° C. to about 300° C., preferably at a temperature within the range from about 0° C. to about 100° C. Particularly effective anionic polymerization initiators are organo lithium compounds having the general formula:

Rliₙ

wherein R is an aliphatic, cycloaliphatic, aromatic or alkyl-substituted aromatic hydrocarbon radical having from 1 to about 20 carbon atoms and n is an integer of 1 to 4.

Conjugated diolefins which may be polymerized anionically include those conjugated diolefins containing from about 4 to about 24 carbon atoms such as 1,3-butadiene, isoprene, piperylene, methylpentadiene, phenyl-butadiene, 3,4-dimethyl-1,3-hexadiene, 4,5-diethyl-1,3-octadiene and the like. Isoprene and butadiene are the preferred conjugated diene monomers for use in the present invention because of their low cost and ready availability. Alkenyl (vinyl) aromatic hydrocarbons which may be copolymerized include vinyl aryl compounds such as styrene, various alkyl-substituted styrenes, alkoxy-substituted styrenes, vinyl napthalene, alkyl-substituted vinyl napthalenes and the like.

The monohydroxylated polydienes are synthesized by anionic polymerization of conjugated diene hydrocarbons with lithium initiators. This process is well known as described in U.S. Pat. Nos. 4,039,593 and Re. 27,145 which descriptions are incorporated herein by reference. Polymerization commences when a monolithium initiator polymerizes the monomers into a living polymer. Typical monolithium living polymer structures containing conjugated diene hydrocarbon monomers are:

X-A-B-Li

X-A-B-A-Li

wherein B represents polymerized units of one conjugated diene hydrocarbon such as butadiene, A represents polymerized units of another conjugated diene such as isoprene, and either A or B may contain one or more vinyl aromatic compounds such as styrene, and X is the residue of a monolithium initiator such as sec-butyllithium. The hydroxyl groups are added by capping the living polymer chain end with ethylene oxide and terminating with a proton donor such as an alcohol.

The preferred monohydroxylated polydiene polymer of the present invention has the structural formula

(HO)ₓ-A-S_{z}-B-(OH)_{y} (I)

wherein A and B are polymer blocks which may be homopolymer blocks of conjugated diolefin monomers, copolymer blocks of conjugated diolefin monomers, or copolymer blocks of diolefin monomers and monoalkenyl aromatic hydrocarbon monomers. These polymers may contain up to 60% by weight of at least one vinyl aromatic hydrocarbon, preferably styrene. Generally, it is preferred that the A blocks should have a greater concentration of more highly substituted aliphatic double bonds than the B blocks have. Thus, the A blocks have a greater concentration of di-, tri-, or tetra-substituted unsaturation sites (aliphatic double bonds) per unit of block mass than do the B blocks. This produces a polymer wherein the most facile epoxidation occurs in the A blocks. The A blocks have a molecular weight of from 100 to 6000, preferably 500 to 4,000, and most preferably 1000 to 3000, and the B blocks have a molecular weight of from 1000 to 15,000, preferably 2000 to 10,000, and most preferably 3000 to 6000. S is a vinyl aromatic hydrocarbon block which may have a molecular weight of from 100 to 10,000. x and y are 0 or 1. Either x or y must be 1, but only one at a time can be 1. z is 0 or 1. Either the A or the B block may be capped with a miniblock of polymer, 50 to 1000 molecular weight, of a different composition, to compensate for any initiation, tapering due to unfavorable copolymerization rates, or capping difficulties. These polymers are epoxidized such that they contain from 0.2 to 7.0 milliequivalents (meq) of epoxy per gram of polymer.

The most highly preferred polymers for use herein are diblock polymers which fall within the scope of formula (I) above. The overall molecular weight of such diblocks may range from 1500 to 15000, preferably 3000 to 7000. Either of the blocks in the diblock may contain some randomly polymerized vinyl aromatic hydrocarbon as described above. For example, where I represents isoprene, B represents butadiene, S represents styrene, and a slash (/) represents a random copolymer block, the diblocks may have the following structures:

I-B-OH I-B/S-OH I/S-B-OH I-I/B-OH

or

B/I-B/S-OH B-B/S-OH I-EB-OH I-EB/S-OH

or

I-S/EB-OH I/S-EB-OH HO-I-S/B HO-I-S/EB

where EB is hydrogenated butadiene, -EB/S-OH means that the hydroxyl source is attached to a styrene mer, and -S/EB-OH signifies that the hydroxyl source is attached to a hydrogenated butadiene mer. This latter case, -S/EB-OH, requires capping of the S/EB “random copolymer” block with a mini EB block to compensate for the tapering tendency of the styrene prior to capping with ethylene oxide. These diblocks are advantageous in that they exhibit lower viscosity and are easier to manufacture than the corresponding triblock polymers. It is preferred that the hydroxyl be attached to the butadiene block because the epoxidation proceeds more favorably with isoprene and there will be a separation between the functionalities on the polymer. However, the hydroxyl may also be attached to the isoprene block if desired. This produces a more surfactant-like molecule with less load bearing capacity. The isoprene blocks may also be hydrogenated.

Certain triblock copolymers are also preferred for use herein. Such triblocks usually include a styrene block or randomly copolymerized styrene to increase the polymers glass transition temperature, compatibility with polar materials, strength, and room temperature viscosity. These triblocks include the following specific structures:

I-EB/S-EB-OH I-B/S-B-OH I-S-EB-OH I-S-B-OH

or

I-I/S-I-OH I-S-I-OH B-S-B-OH B-B/S-B-OH

or

I-B/S-I-OH I-EB/S-I-OH

or

I-B-S-OH I-EB-S-OH HO-I-EB-S

The latter group of polymers specified in the last line above wherein the styrene block is external are represented by the formula

(HO)ₓ-A-B-S-(OH_{y} (II)

where A, B, S, x, and y are as described above. These polymers and the other triblocks shown above are particularly advantageous for introducing blocks of epoxy functionality into the monohydroxylated polymers at multiple sites.

Epoxidation of the monohydroxylated base polymer can be effected by reaction with organic peracids which can be preformed or formed in situ. Suitable preformed peracids include peracetic and perbenzoic acids. In situ formation may be accomplished by using hydrogen peroxide and a low molecular weight fatty acid such as formic acid. Alternatively, hydrogen peroxide in the presence of acetic acid or acetic anhydride and a cationic exchange resin will form a peracid. The cationic exchange resin can optionally be replaced by a strong acid such as sulfuric acid or p-toluenesulfonic acid. The epoxidation reaction can be conducted directly in the polymerization cement (polymer solution in which the polymer was polymerized) or, alternatively, the polymer can be redissolved in an inert solvent. These methods are described in more detail in U.S. Pat. Nos. 5,229,464 and 5,247,026 which are herein incorporated by reference.

The molecular weights of linear polymers or unassembled linear segments of polymers such as mono-, di-, triblock, etc., arms of star polymers before coupling are conveniently measured by Gel Permeation Chromatography (GPC), where the GPC system has been appropriately calibrated. For anionically polymerized linear polymers, the polymer is essentially monodisperse (weight average molecular weight/number average molecular weight ratio approaches unity), and it is both convenient and adequately descriptive to report the “peak” molecular weight of the narrow molecular weight distribution observed. Usually, the peak value is between the number and the weight average. The peak molecular weight is the molecular weight of the main species shown on the chromatograph. For polydisperse polymers the weight average molecular weight should be calculated from the chromatograph and used. For materials to be used in the columns of the GPC, styrene-divinyl benzene gels or silica gels are commonly used and are excellent materials. Tetrahydrofuran is an excellent solvent for polymers of the type described herein. A refractive index detector may be used.

If desired, these block copolymers can be partially hydrogenated. Hydrogenation may be effected selectively as disclosed in U.S. Patent Reissue 27,145 which is herein incorporated by reference. The hydrogenation of these polymers and copolymers may be carried out by a variety of well established processes including hydrogenation in the presence of such catalysts as Raney Nickel, nobel metals such as platinum and the like, soluble transition metal catalysts and titanium catalysts as in U.S. Pat. No. 5,039,755 which is also incorporated by reference. The polymers may have different diene blocks and these diene blocks may be selectively hydrogenated as described in U.S. Pat. No. 5,229,464 which is also herein incorporated by reference. Partially unsaturated monohydroxylated polymers are preferred for use herein in order to allow further functionalization such as to make the epoxidized polymers of this invention.

The crosslinking agents which are useful in the present invention are amino resins. For the purposes of this invention, an amino resin is a resin made by reaction of a material bearing NH groups with a carbonyl compound and an alcohol. The NH bearing material is commonly urea, melamine, benzoguanamine, glycoluril, cyclic ureas, thioureas, guanidines, urethanes, cyanamides, etc. The most common carbonyl component is formaldehyde and other carbonyl compounds include higher aldehydes and ketones. The most commonly used alcohols are methanol, ethanol, and butanol. Other alcohols include propanol, hexanol, etc. American Cyanamid (renamed CYTEC) sells a variety of these amino resins, as do other manufacturers. American Cyanamid's literature describes three classes or “types” of amino resins that they offer for sale.

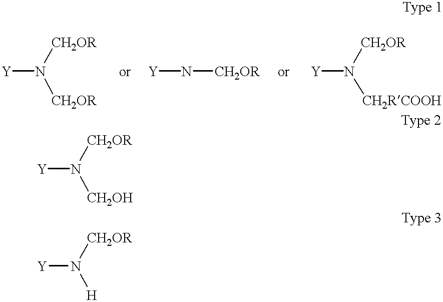

where Y is the material that bore the NH groups, the carbonyl source was formaldehyde and R is the alkyl group from the alcohol used for alkylation. Although this type of description depicts the amino resins as monomeric material of only one pure type, the commercial resins exist as mixtures of monomers, dimers, trimers, etc. and any given resin may have some character of the other types. Dimers, trimers, etc. also contain methylene or ether bridges. Generally, type 1 amino resins are preferred in the present invention.

The amino resin must be compatible with the epoxidized monohydroxylated polydiene polymer. A compatible amino resin is defined as one which gives a phase stable blend with the monohydroxylated polydiene polymer at the desired concentration and at the temperature to which the mixture will be heated as the composition is being mixed and applied.

For example, the following type 1 amino resins can be used to achieve the purpose of the present invention: CYMEL® 1156—a melamine-formaldehyde resin where R is C₄H₉, CYMEL® 1170—a glycoluril—formaldehyde resin where R is C₄H₉, CYMEL® 1141—a carboxyl modified amino resin where R is a mixture of CH₃ and i-C₄H₉ and BEETLE® 80—a urea-formaldehyde resin where R is C₄H₉. All of these products are made by American Cyanamid Company and are described in its publication 50 Years of Amino Coating Resins, edited and written by Albert J. Kirsch, published in 1986 along with other amino resins useful in the present invention.

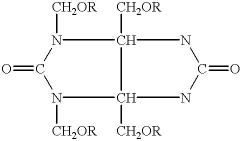

CYMEL® 1170 is the following glycoluril-formaldehyde resin where R is C₄H₉: Another is BEETLE® 80 urea-formaldehyde resin where R is C₄H₉ whose ideal monomeric structure is depicted:

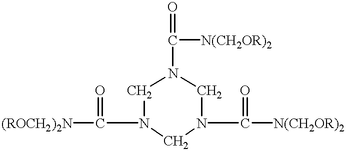

In the crosslinkable composition, the epoxidized monohydroxylated polydiene polymer should comprise from 50 to 98% by weight (% w) of the polymer/amine resin composition. Thus, the amino resin will comprise from 50 to 2% w of the composition. If the polymer is used at less than 50% w, then the cured composition will be too brittle for most applications. If it is used at more than 98%, then the concentration of crosslinker will be too low and the composition will not cure to high strength.

The crosslinked materials of the present invention are useful in adhesives (including pressure sensitive adhesives, contact adhesives, laminating adhesives, assembly adhesives and structural adhesives), sealants, coatings, films (such as those requiring heat and solvent resistance), etc. However, it may be necessary for a formulator to combine a variety of ingredients together with the polymers of the present invention in order to obtain products having the proper combination of properties (such as adhesion, cohesion, durability, low cost, etc.) for particular applications. Thus, a suitable formulation might contain only the polymers of the present invention and the amino resin curing agent. However, in most adhesive, coating and sealant applications, suitable formulations would also contain various combinations of resins, plasticizers, fillers, solvents, stabilizers and other ingredients such as asphalt. The following are some typical examples of formulating ingredients for adhesives, coatings and sealants.

In adhesive applications, as well as in coatings and sealants, it may be necessary to add an adhesion promoting or tackifying resin that is compatible with the polymer. A common tackifying resin is a diene-olefin copolymer of piperylene and 2-methyl-2-butene having a softening point of about 95° C. This resin is available commercially under the tradename Wingtack® 95 and is prepared by the cationic polymerization of 60% piperlene, 10% isoprene, 5% cyclo-pentadiene, 15% 2-methyl-2-butene and about 10% dimer, as taught in U.S. Pat. No. 3,577,398. Other tackifying resins may be employed wherein the resinous copolymer comprises 20-80 weight percent of piperylene and 80-20 weight percent of 2-methyl-2-butene. The resins normally have ring and ball softening points as determined by ASTM method E28 between about 80° C. and 115° C.

Aromatic resins may also be employed as tackifying agents, provided that they are compatible with the particular polymer used in the formulation. Normally, these resins should also have ring and ball softening points between about 80° C. and 115° C. although mixtures of aromatic resins having high and low softening points may also be used. Useful resins include coumarone-indene resins, polystyrene resins, vinyl toluene-alpha methylstyrene copolymers and polyindene resins.

Other adhesion promoting resins which are also useful in the compositions of this invention include hydrogenated rosins, esters of rosins, polyterpenes, terpenephenol resins and polymerized mixed olefins, lower softening point resins and liquid resins. An example of a liquid resin is Adtac® LV resin from Hercules. To obtain good thermo-oxidative and color stability, it is preferred that the tackifying resin be a saturated resin, e.g., a hydrogenated dicyclopentadiene resin such as Escorez® 5000 series resin made by Exxon or a hydrogenated polystyrene or polyalphamethylstyrene resin such as Regalrez® resin made by Hercules. The amount of adhesion promoting resin employed varies from 0 to 400 parts by weight per hundred parts rubber (phr), preferably between 20 to 350 phr, most preferably 20 to 150 phr. The selection of the particular tackifying agent is, in large part, dependent upon the specific polymer employed in the respective adhesive composition.

A composition of the instant invention may contain plasticizers, such as rubber extending plasticizers, or compounding oils or organic or inorganic pigments and dyes. Rubber compounding oils are well-known in the art and include both high saturates content oils and high aromatics content oils. Preferred plasticizers are highly saturated oils, e.g. Tufflo® 6056 and 6204 oil made by Arco and process oils, e.g. Shellflex® 371 oil made by Shell. The amounts of rubber compounding oil employed in the invention composition can vary from 0 to about 500 phr, preferably between about 0 to about 100 phr, and most preferably between about 0 and about 60 phr.

Optional components of the present invention are stabilizers which inhibit or retard heat degradation, oxidation, skin formation and color formation. Stabilizers are typically added to the commercially available compounds in order to protect the polymers against heat degradation and oxidation during the preparation, use and high temperature storage of the composition.

Various types of fillers and pigments can be included in the formulation. This is especially true for exterior coatings or sealants in which fillers are added not only to create the desired appeal but also to improve the performance of the coatings or sealants such as its weatherability. A wide variety of fillers can be used. Suitable fillers include calcium carbonate, clays, talcs, silica, zinc oxide, titanium dioxide and the like. The amount of filler usually is in the range of 0 to about 65% w based on the solvent free portion of the formulation depending on the type of filler used and the application for which the coating or sealant is intended. An especially preferred filler is titanium dioxide. Additional stabilizers known in the art may also be incorporated into the composition. These may be for protection during the life of the article against, for example, oxygen, ozone and ultra-violet radiation. However, these additional stabilizers should be compatible with the essential stabilizers mentioned hereinabove and their intended function as taught herein.

All adhesive, coating and sealant compositions based on the epoxidized monohydroxylated polymers of this invention will contain some combination of the various formulating ingredients disclosed herein. No definite rules can be offered about which ingredients will be used. The skilled formulator will choose particular types of ingredients and adjust their concentrations to give exactly the combination of properties needed in the composition for any specific adhesive, coating or sealant application.

The only two ingredients that will always be used in any adhesive, coating or sealant are the epoxidized polymer and the amino resin curing agent. Beyond these two ingredients, the formulator will choose to use or not to use among the various resins, fillers and pigments, plasticizers, reactive oligomers, stabilizers and solvents.

Adhesives are frequently thin layers of sticky compositions which are used in protected environments (adhering two substrates together). Therefore, unhydrogenated epoxidized polymers will usually have adequate stability so resin type and concentration will be selected for maximum stickiness without great concern for stability, and pigments will usually not be used.

Coatings are frequently thin, non-sticky, pigmented compositions applied on a substrate to protect or decorate it. Therefore, hydrogenated epoxidized polymers may be needed to give adequate durability. Resins will be selected to assure maximum durability and minimum dirt pick-up. Fillers and pigment will be selected carefully to give appropriate durability and color. Coatings will frequently contain relatively high solvent concentration to allow easy application and give a smooth dry coating.

Sealants are gapfillers. Therefore, they are used in fairly thick layers to fill the space between two substrates. Since the two substrates frequently move relative to each other, sealants are usually low modulus compositions capable of withstanding this movement. Since sealants are frequently exposed to the weather, the hydrogenated epoxidized polymers are usually used. Resins and plasticizers will be selected to maintain low modulus and minimize dirt pick-up. Fillers and pigment will be selected to give appropriate durability and color. Since sealants are applied in fairly thick layers, solvent content is as low as possible to minimize shrinkage.

A formulator skilled in the art will see tremendous versatility in the epoxidized monohydroxylated polymers of this invention to prepare adhesives, coatings and sealants having properties suitable for many different applications.

The adhesive, coating and sealant compositions of the present invention can be prepared by mixing the components together until a homogeneous blend is obtained. Various methods of blending are known to the art and any method that produces a homogenous blend is satisfactory. Frequently, the components can be blended together using solvent to control viscosity. Suitable solvents include common hydrocarbons, esters, ethers, ketones and alcohols as well as mixtures thereof. If solvent content is restricted or in solvent-free compositions, it may be possible to heat the components to help reduce viscosity during mixing and application.

A preferred use of the present formulation is in pressure-sensitive adhesive tapes and of labels. The pressure-sensitive adhesive tape comprises a flexible backing sheet and a layer of the adhesive composition of the instant invention coated on one major surface of the backing sheet. The backing sheet may be a plastic film, paper or any other suitable material and the tape may include various other layers or coatings, such as primers, release coatings and the like, which are used in the manufacture of pressure-sensitive adhesive tapes. Alternatively, when the amount of tackifying resin is zero, the compositions of the present invention may be used for adhesives that do not tear paper and molded goods and the like.

Coating compositions of this invention can be used in many applications, depending on the hardness, adhesion, durability and cure conditions chosen by the formulator. A fairly soft coating formulated for low adhesion could be used as a protective strippable coating. A fairly soft coating formulated for high adhesion could be useful as a shatter retentive coating for glass bottles for carbonated beverages A fairly hard coating formulated for high adhesion and long durability could be used as a corrosion protective coating for metals such as lawn equipment, automobiles, etc.

Sealant compositions of this invention can be used for many applications. Particularly preferred is their use as gap fillers for constructions which will be baked (for example, in a paint baking oven) after the sealant is applied. This would include their use in automobile manufacture and in appliance manufacture. Another preferred application is their use in gasketing materials, for example, in lids for food and beverage containers.

Asphalt is another common material which can advantageously be combined with the polymers of the present invention. The asphalt may comprise a bituminous component which may be a naturally occurring bitumen or derived from a mineral oil. Also, petroleum derivatives obtained by a cracking process, pitch and coal tar can be used as the bituminous component as well as blends of various bituminous materials. Examples of suitable components include distillation or “straight-run bitumens,” precipitation bitumens, e.g. propane bitumens, blown bitumens and mixtures thereof. Other suitable bituminous components include mixtures of one or more of these bitumens with extenders such as petroleum extracts, e.g. aromatic extracts, distillates or residues, or with oils. Compatible asphalts are preferred for use herein. Compatible asphalts are those which will give a blend which does not phase separate upon standing. The amount of asphalt used in the formulation can vary widely depending on the performance requirements of the particular application. However, asphalt will generally be in the formulation at about 0-95 % w, more preferably 0-70% w and most preferably 0-30% w.

### EXAMPLES

The following examples demonstrate the utility of the epoxidized monohydroxylated polymers in amino resin cured compositions. The amino resin used was CYMEL® 1156, a melamine-formaldehyde resin where R is C₄H₉. The acid used to catalyze the amino resin/hydroxyl and amino resin/epoxy reactions was CYCAT® 600, dodecyl benzene sulfonic acid (a 70% weight solution in isopropyl alcohol). The compositions were mixed and coated from a 65 percent by weight (% w) solids solution of the ingredients in a solvent blend composed of 90% w of an aliphatic hydrocarbon solvent, VM&P naphtha, and 10% w n-butanol. The following formulation, given in parts by weight, was used.

| Composition | pbw |
|---|---|
| Polymer | 80 |
| CYMEL ® 1156 | 18 |
| CYCAT ® 600 | 2 |
| VM&P Naphtha | 60 |
| n-Butanol | 7 |

The following polymers were tested in this formulation. Polymer 1 was a 3000 molecular weight (MW) hydrogenated polybutadiene (EB) having a single hydroxyl group (OH) on one end. Polymer 2 was a 2000 MW polyisoprene (I)—4000 MW hydrogenated (polybutadiene (EB) diblock polymer having a single OH on one end. Polymer 3 was a 2000 MW polyisoprene (I)—4000 MW polystyrene/hydrogenated polybutadiene (S/EB) copolymer having a single OH on one end. The 4000 MW S/EB block in Polymer 3 was 2500 MW S and 1500 MW EB. Polymer 4 was Polymer 2 epoxidized to an epoxy content of 1.5 meg/gm. Polymer 5 was Polymer 3 epoxidized to an epoxy content of 1.5 meq/gm. Polymer 6 is a triblock polymer which had the same S/EB copolymer block as Polymer 3. However, Polymer 6 had a 1000 MW block of epoxidized polyisoprene on each end of the S/EB center block and had no OH group. Polymer 7 was a 4000 MW hydrogenated polybutadiene (EB) having a single OH group on both ends.

Coatings, about 2 mil thickness dry, were drawn onto aluminum panels with #·52 wire wound rod. The coatings were cured by baling 20 minutes at 175° C. They were evaluated qualitatively for their suitability for use as coatings. The following are the results.

| Polymer | Type | Appearance of Coating |
|---|---|---|
| 1 | EB-OH | Very Tacky |
| 2 | I-EB-OH | Tacky |
| 3 | I-S/EB-OH | Tacky |
| 4 | Epoxidized I-EB-OH | Non-tacky, elastomeric |
| 5 | Epoxidized I-S/EB-OH | Non-tacky, elastomeric |
| 6 | Epoxidized I-S/EB-I | Non-tacky, elastomeric |
| 7 | HO-EB-OH | Non-tacky, elastomeric |

Results with Polymer 1 clearly show that a melamine cured EB-OH monohydroxylated polydiene polymer made from only one diene monomer is not suitable for use as a coating because it is very sticky. Results with Polymers 2 and 3 show that a monohydroxylated polydiene polymer made from at least two diene monomers and subsequently selectively hydrogenating it, thereby putting an unsaturated I block on the end opposite the OH, performs significantly better than Polymer 1. However, these coatings are still not suitable because they are still sticky. Results for Polymers 4 and 5 show that epoxidation of the I block on the end opposite the OH converts the monohydroxylated polydiene polymers made from at least two diene monomers into useful coating compositions. Results for Polymers 6 and 7 confirm that a polymer with epoxy groups on both ends or an OH group on both ends is useful in coatings, as is already well known.

We claim:

1. A crosslinkable composition comprising from 50 to 98 percent by weight of an epoxidized monohydroxylated polydiene polymer which is comprised of at least two polymerizable ethenically unsaturated hydrocarbon monomers wherein at least one is a diene monomer which yields unsaturation which is suitable for epoxidation, and from 50 to 2 percent by weight of an amino resin.

2. The composition of claim 1 wherein said polymer has been epoxidized such that it contains from 0.2 to 7.0 meq of epoxy per gram of polymer.

3. A coating comprising the composition of claim 1.

4. An adhesive comprising the composition of claim 1.

5. A sealant comprising the composition of claim 1.

6. The composition of claim 1 wherein the polymer is an epoxidized monohydroxylated polydiene polymer which has the formula
(HO)ₓ-A-S_{z}-B-(OH)_{y}
wherein A and B are polymer blocks which may be homopolymer blocks of conjugated diolefin monomers, copolymer blocks of conjugated diolefin monomers, or copolymer blocks of diolefin monomers and monoalkenyl aromatic hydrocarbon monomers, S is a vinyl aromatic hydrocarbon block, x and y are 0 or 1 and either x or y must be 1 but only one at a time can be 1, and z is 0 or 1, and wherein the polymer contains from 0.2 to 7.0 meq of epoxy per gram of polymer.

7. The composition of claim 6 wherein the A blocks have a molecular weight of from 100 to 6000 and the B blocks have a molecular weight of from 1000 to 15,000 and the S blocks have a molecular weight of from 500 to 10,000.

8. A coating comprising the composition of claim 6.

9. An adhesive comprising the composition of claim 6.

10. A sealant comprising the composition of claim 6.

11. The composition of claim 1 wherein the polymer is an epoxidized monohydroxylated polydiene polymer which has the formula
(HO)ₓ-A-B-S-(OH)_{y}
wherein A and B are polymer blocks which may be homopolymer blocks of conjugated diolefin monomers, copolymer blocks of conjugated diolefin monomers, or copolymer blocks of diolefin monomers and monoalkenyl aromatic hydrocarbon monomers, S is a vinyl aromatic hydrocarbon block, x and y are 0 or 1 and either x or y must be 1 but only one at a time can be 1, and z is 0 or 1, and wherein the polymer has an epoxy content of from 0.2 to 7.0 meq of epoxy per gram of polymer.

12. The composition of claim 11 wherein the A blocks have a molecular weight of from 100 to 6000 and the B blocks have a molecular weight of from 1000 to 15,000 and the S blocks have a molecular weight of from 500 to 10,000.

13. A coating comprised of the composition of claim 11.

14. An adhesive comprised of the composition of claim 11.

15. A sealant comprised of the composition of claim 11.
